(19) United States
(12) Patent Application Publication
(10) Pub. No.: US 2004/0007700 A1
(43) Pub. Date: Jan. 15, 2004

(54) Non-snagging protective guide for fish tapes

(76) Inventor: Danny G. Hazel, Culpeper, VA (US)

Correspondence Address: STEPTOE & JOHNSON PLLC, Sixth Floor, Bank One Center, P.O. Box 2190, Clarkburg, WV, 26302-2190, US

(21) Appl. No.: 10/611,709

(22) Filed: Jul. 1, 2003

Related U.S. Application Data
(60) Provisional application No. 60/392,780, filed on Jul. 1, 2002.
(60) Provisional application No. 60/412,128, filed on Sep. 18, 2002.

(51) Int. Cl. B66F 3/00

(52) U.S. Cl. 254/134.3 FT

(57) ABSTRACT

A means for encasing a connection zone formed by joining an end of a fish tape to an object, e.g., a cable or wire, to be fished through an opening and/or conduit. The encasing means preferably is a protective guide being a hollow tube generally cone or funnel shaped for encasing the connection zone. By encasing the connection zone, the protective guide creates a smooth transition from the relatively small fish tape wire to the relatively large object being fished. The protective guide reduces the likelihood of the connection zone getting snagged on an opening or conduit through which a wire or cable is to be fished. The protective guide can have one or more lateral slits through its outer surface and extending from a second larger end toward a first smaller end for decreasing the outside diameter of the protective guide upon the exertion of pressure against the protective guide. The lateral slits allow the protective guide to adapt to external inward pressure applied, for example, by the walls of a narrow cavity or opening.

### CROSS-REFERENCE TO RELATED APPLICATIONS

This application claims the benefit of U.S. application Ser. No. 60/392,780 filed Jul. 1, 2002 and U.S. application Ser. No. 60/412,128, filed Sep. 19. 2002.

### BACKGROUND OF THE INVENTION

1. Field of the Invention

The present invention is directed generally to fish tapes and all means for fishing an object through blind or inaccessible cavities, and more specifically, to a non-snagging protective guide for use with fishing an object.

2. Related Art

A fish tape most commonly is used to pull electrical wire or cable through conduits, tight passageways, and blind and inaccessible openings or cavities. The fish tape may include a wire which is pushed through a small opening in one end of the cavity and out the opening at the other end. Then, the electrical wire. cable, or other linear object to be fished through the opening, is attached to the end of the fish tape. The fish tape, with the attached object, is then pulled back through the cavity and out the first opening. Once the object is successfully fished through the opening and/or cavity, it can be used in the desired manner. For example, after successfully fishing an electrical cable through a conduit, the desired electrical connection can be made.

A common problem encountered when using fish tapes is that the fish tape and object being fished combination often gets jammed or hung up while being pulled through the conduit or cavity. Jamming can result in damage to the object being fished, as well as, to any item within the cavity. Also, the leading end of the fish tape frequently gets stuck while passing through the opening in the conduit or passageway, bends in the cavity, or snags on obstacles within the cavity or conduit. The fish tape wire is smaller than the cable (or other linear object) being “fished.” As a result, the connection of the fish tape and cable (referred to generally as a “connection zone”) creates corners, edges, or protrusions that often get caught when the fish tape and cable contact the edge of the opening or an obstruction within the cavity. The object being fished often gets caught because it protrudes past the fish tape wire and catches on objects, i.e., there is not a smooth transition in size from the smaller fish tape wire to the larger object which is being fished.

If the fish tape wire gets stuck, and if there is access, the fish tape wire simply can be positioned so that it passes through the opening. This usually requires a person at each end of the procedure—one to guide the wire through the obstruction at one end of the cavity and one person to pull the wire out the other end. Repeatedly pushing and pulling by one person can sometimes free up the wire so it slides through the opening, or past the obstruction, but this requires several attempts and sometimes is not successful. Usually the second person is required to reposition, or guide, the fish tape past the obstacle. Therefore, there is a need for an apparatus that eliminates and prevents an object being fished from getting snagged on obstacles in a conduit.

Efforts have been made to overcome the problems encountered when using fish tapes. For example, U.S. Pat. No. 5,505,432 issued to Noonan, discloses an anti-snagging protective device for use with a fish tape to minimize jams in an opening or conduit. The device in Noonan is a spherical roller for riding over obstructions in a conduit, thereby allowing the fish tape to be fed and retracted freely through the conduit. However, there remains a connection formed at the point where a wire to be fished is connected to the roller. This connection zone still is prone to snagging. Noonan offers no solution to the snagging problem other than to wrap the connection zone in electrical tape. Thus, there remains a need for an apparatus for creating a smooth transition from an end of a fish tape to a wire or cable being fished in order to reduce the likelihood of the fish tape/cable combination getting snagged in an opening or conduit.

In U.S. Pat. No. 5,480,203 to Favalora, et al., a pulling tool is disclosed having a mesh sleeve with an open end for receiving and holding the ends of multiple cables and a closed end for a pulling member. The pulling tool is designed specifically to protect the fragile connectors of fiber optic cables. In operation, the connector ends of fiber optic cables are inserted into the open end of the sleeve wherein the open end is bound with tape to hold the ends of the cables within the sleeve. Once they are secured, the closed end of the pulling tool is attached to a pulling member such that the pulling tool with the cables can be pulled through a conduit. Thus, there is still a need for an apparatus for fishing a cable through a conduit that does not require any tape or other additional means for closing one end.

Similar to Favalora, U.S. Pat. No. 5,129,027 to Boero et al. discloses a device for protecting connectors on the end of cables. Specifically, the device has a plurality of grooves adapted for receiving an end of an optical fiber ribbon. This device has a very limited use in that it is adapted for use solely with ribbon type of cable.

In U.S. Pat. No. 5,938,181 to Holden, a fish leader is disclosed having a coupler attached at one end which is used to attach to a conventional computer cable connector. Once the coupler of the fish leader is secured to the computer cable, the fish leader is used in a conventional manner to pull the computer cable through a conduit. One disadvantage with the Holden fish leader is that the coupler is a fixed and rigid shape in order to accommodate the shape of a conventional computer cable connector. Thus, as with the others, the Holden fish leader will not prevent snags.

### SUMMARY OF THE INVENTION

The present invention solves the foregoing problems by providing a protective guide for a connection zone that creates a smooth, i.e., seamless or relatively seamless, transition from a relatively small fish tape to a relatively large object being fished.

An aspect of the invention is a means for encasing a connection zone formed where an end of a fish tape is joined to a cable or wire (an “object”) to be pulled through an opening, thereby creating a smooth transition from the fish tape to the cable or wire being fished.

Another aspect of the invention is an apparatus, including a protective guide being conical in shape and having an outside diameter, a length, a first end having a first opening with a first diameter, a second end having a second opening with a second diameter, an outer surface, and an inner surface, wherein the outside diameter of the protective guide tapers from the second end to the first end, and wherein the first end terminates in a point; a slot in the first end adapted for receiving an end of a fish tape; and one or more lateral slits through the outer surface of the protective guide for decreasing the outside diameter of the protective guide in response to external pressure.

Another aspect of the invention is a method of fishing a cable through an opening, including the steps of: (a) feeding a fish tape into a first opening in a conduit or blind cavity and out a second opening in the conduit or the blind cavity; (b) inserting an end of a fish tape through a first small opening in a cone-shaped protective guide; (c) connecting the end of the fish tape to a cable or wire, thereby forming a connection zone; (d) retracting the fish tape back toward the first small opening in the protective guide such that the connection zone is contained within the protective guide; and (e) pulling the fish tape back out and through the opening in the conduit or blind cavity.

A feature of the invention is that it creates a smooth transition from a smaller fish tape wire to a larger object being fished thereby providing protection and eliminating edges that can get caught on openings or obstructions.

Another feature of the invention is that the protective guide can be any “hollow” shape, such as a modified bell-shape or a bullet shape, as long as there is a smooth transition from the small end to the larger end.

Another feature of the invention is that the protective guide need not be a traditional cone or funnel shape, but instead can be a modified cone or funnel shape having curved walls as opposed to traditionally straight-line cone walls.

An advantage of the invention is that it can be fabricated from any material that will hold the cone shape.

Another advantage of the invention is that there are no moving parts or fasteners used in its design and construction.

Another advantage of the invention is that it enables a fish tape to function as intended without getting caught on obstructions, corners, edges, or other such protrusions.

Another advantage of the invention is that it makes some projects possible which otherwise would not be possible without opening the cavity to gain access.

Another advantage of the invention is that it increases productivity and also eliminates the need for a second person to guide a fish tape through obstructions in an opening or cavity.

Another advantage of the invention is its simplicity of design, lack of mechanical complexities, and inexpensive cost of production.

Another advantage of the invention is that it simply slides onto a fish tape wire, i.e., there are no connectors required, and it works with any fish tape device and any item to be fished through an opening.

Another advantage of the invention is that it can be cut to size , while on the job, to accommodate very tight openings. More specifically, the second (large) end of the protective guide can be cut to provide a reduced-diameter opening as needed. Similarly, the first (small) end of the protective guide can be enlarged to accommodate different size fish tapes.

Another advantage of the invention is that the first end (the small leading end) of the protective guide is barely large enough to slide onto the fish tape wire, thereby minimizing the likelihood of the leading edge of the protective guide getting caught on an opening to a cavity, or on obstructions within the cavity.

Another advantage of the invention is that the second end (the large end) need only be slightly larger than the item being “fished,” thereby decreasing the minimum size of the opening through which the protective guide can be fished.

Another advantage of the invention is that the cone or funnel shape concept is successful for all sizes of objects being “fished.”

Another advantage of the invention is that a single protective guide can be used for fishing all sizes of wire—as long as the opening is large enough to accommodate the protective guide. For example, the same size protective guide can be used to fish a ½ inch object and a 6 inch object. The second end of the protective t)tide would simply have to be just a little larger than 6 inches in diameter to accommodate the 6 inch object. To use this same protective guide to fish the ½ inch wire through a smaller opening, a user simply would cut the protective guide along an axis perpendicular to its longitudinal axis at a point where the outside diameter of the protective guide was just larger than ½ inch.

Another advantage of the invention is that with the protective guide, objects can be “fished” through smaller openings, as the opening need only be slightly larger than the object being “fished.”

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 shows a side view of a fish tape wire being inserted into a protective guide of the present invention;

FIG. 2 shows a side view of a connection zone formed where an end of a fish tape wire is joined to a cable or wire to be fished through an opening;

FIG. 3 shows a side view of a protective guide encasing the connection zone;

FIG. 4 shows a side view of an alternative embodiment of the protective guide of the present invention; and

FIG. 5 shows a side view of another alternative embodiment of the protective guide of the present invention.

### EMBODIMENTS OF THE INVENTION

Referring to the figures, the present invention is a protective guide 100 having a means for encasing a connection zone 208 formed where an end of a fish tape 102 is joined to an object 202 that is to be pulled, or “fished,” through an opening. Non-limiting examples of an object 202 to be fished through an opening include cables and wires. The protective guide 100 creates a smooth transition from the fish tape 102 to the object 202, thereby preventing the connection zone 208 from snagging on obstacles within an opening or on the opening itself. “Connection zone” 208 is defined as the region where an end of fish tape 102 is joined to an object 202 to be fished through an opening. More specifically, the connection zone 208 is the region (i) where a transition is made from a fish tape 102 to an object 202 being fished, and (ii) having projections, protrusion, or edges—resulting from the joining of the fish tape 102 to the object 202 to be fished—likely to snag in an opening or conduit.

This invention pertains to any industry, profession, or operation where an object 202 has to be pulled or fished through an inaccessible cavity. The invention can be used with a fish tape 102, or any other form of fishing device. Application of the invention is not limited to fishing cable or electrical wiring—it can be used when any linear object needs to be pulled through a cavity or conduit (i.e., conduit, hose, tubing, cable, rope, pipe, etc). There likewise is no limitation placed on the invention due to the size of objects being fished. The invention works equally well with microscopic size objects as well as large objects.

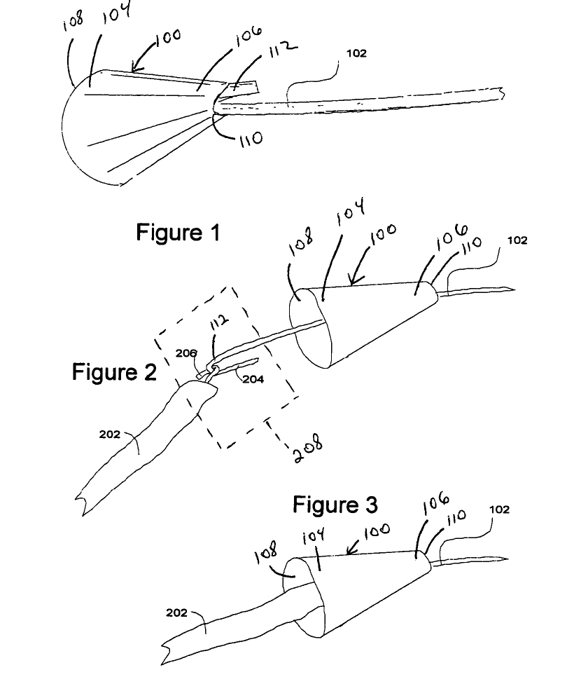

Referring now to FIG. 1. all exemplary means for encasing a connection zone 208 is shown generally as protective guide 100. Protective guide 100 preferably is a hollow tube having a conical or bullet shape to facilitate the moving of the protective guide 100 through an opening. More specifically, protective guide 100 has a first end 106, having a first opening 110, and a second end 104, having a second opening 108. In addition, the protective guide 100 tapers from the second end 104 to the first end 106, such that the outside diameter of the protective guide 100 is greater at the second end 104 than at the first end 106. Correspondingly, the diameter of the second opening 108 is greater than the diameter of the first opening 110. The first opening 110 of the protective guide 100 also is adapted for receiving an end 112 of a fish tape 102 which generally is relatively small in comparison to an item being fished. The second opening 108 is adapted for receiving the object 202 being fished, which generally is relatively large in comparison to the end 112 of the fish tape 102.

As shown most clearly in FIGS. 2-4, protective guide 100 has an inner surface and an outer surface. Outer surface of the protective guide 100 optionally but preferably is a non-stick surface—meaning that it either is coated with or made from a “non-stick” material, such as one of the family of fluoropolymers. Non-limiting examples of non-stick materials include: Delron®, chlorotrifluoroethylene (CTFE or Kel-F®), polytetrafluoroethylene (PTFE or Teflon®), and silicone polymers. As a result of having a non-stick surface, outer surface has a reduced coefficient of friction thereby allowing protective guide 100 to pass through an opening with less resistance.

The materials used to construct the protective guide 100 are nearly unlimited. The protective guide 100 can be made virtually of any material, depending mostly on the requirements of the specific application. Some applications may require a material that minimizes friction and wear by using a softer or more flexible material. Other applications may require added strength and resistance to abrasion. Non-limiting examples of materials from which the protective guide 100 can be made include: compressed wood fiber products, paper, leather, cloth, metal, plastic, composite materials, and alloys or combinations thereof. Similarly, the size of the protective guide 100 is determined by the size of the object 202 being fished and the size of the opening through which it is being fished.

The protective guide 100 of this invention preferably is a cone or funnel shaped apparatus that slides onto a fish tape 102 before the fish tape 102 is connected to an object 202 to be fished through an opening or conduit. The small leading end (the first end 106) of the protective guide 100 is just large enough to allow the protective guide 100 to slide onto the end of the fish tape 102. The small size of the first end 106 of the protective guide 100 reduces the likelihood of the leading edge of the first opening 110 of the protective guide 100 getting caught on an opening to a cavity, or on an obstruction within the cavity. The larger trailing end (the second end 104) of the protective guide 100 need only be slightly larger than the object 202 being fished, thereby reducing the minimum size of the opening through which a wire or cable can be fished using the protective guide 100 of the present invention.

The protective guide 100 need not be a traditional cone or funnel shape. The preferred embodiment of the protective guide is conical in shape for convenience purpose only. Instead, the protective guide 100 can be a modified cone or funnel shape having curved walls as opposed to traditionally straight-line cone walls. The protective guide 100 can be any “hollow” shape, to accommodate the connection zone 208, as long as there is a smooth transition from the small first end 106 to the larger second 104 end, such as with a modified bell-shape or a bullet shape. In other words, the “walls” of the protective guide 100 from the first end 106 to the second end 104 can be straight as in a traditional cone or have a degree of curve. For simplicity, and not limitation, the protective guide 100 will be referred to in this application as having a conventional cone or funnel shape.

The cone or funnel-shaped protective guide 100 can be used to successfully fish for all sizes of objects 202. A single protective guide 100 can be used for fishing all sizes of wire or cable (object 202) as long as the opening and cavity through which the object 202 is to be fished are large enough to accommodate the protective guide 100. For example, the same size protective guide 100 can be used to fish an object 202 having a ½ inch diameter as well as an object 202 having a 6-inch diameter. The second end 104 of the protective guide 100 simply would have to be just a little larger than 6 inches in diameter to accommodate the 6-inch diameter object 202. In order to use this same protective guide 100 to fish the ½ inch diameter object 202 through a smaller opening, a user could cut off the second end 104 of the protective guide 100 such that the maximum outside diameter of the protective guide 100 is just larger than ½ inch.

In summary, the same cone or funnel-shaped protective guide 100 works for all sizes of objects 202 being fished. The larger the diameter of the object 202 being fished, the longer the protective guide 100 must be in order to cover the front edges of the object 202. In size-critical situations where the opening or conduit has size limitations, the protective guide 100 simply would be cut in length so that the second end 104 of the protective guide 100 is just larger than the front edges (the diameter) of the object 202 being fished. Thus, the protective guide 100 is a length slightly longer than the connection zone 208 formed where the fish tape 102 and the object 202 are joined.

FIG. 4 shows an alternative embodiment of a protective guide 400 of the present invention. In this embodiment, the first end 402 of the protective guide 400 ends in a point 404. Point 404 reduces the outside diameter of the protective guide 400 at its first end 402. thereby reducing the surface area of the first end 402 and decreasing the likelihood of protective guide 400 getting snagged as it is being pulled through an opening. Also in this alternative embodiment, first end 402 optionally, but preferably, includes a slot 410 cut into a side wall of the protective guide 400 at the point 404 to accommodate the end 112 of a fish tape 102. More specifically, slot 410 allows the end 112 in the fish tape 102 to be inserted into and through the point 404 at the first end 402 of the protective guide 400. Slot 410 preferably is used in this embodiment because point 404 is too small for the end 112 of the fish tape 102 to pass through. Slot 410 need only extend a length into protective guide 400 toward second end 406 until the diameter of the protective guide 400 at the distal end of the slot 410 is sufficiently large to allow the end 112 of the fish tape 102 to pass through.

The use of a single slot 410 is for convenience purpose only. It would be readily apparent to one of ordinary skill in the relevant art to use multiple slots 410. When using a single slot 410, the strength and integrity of the point 404 at the first end 402 of the protective guide 400 is maintained. When using two or more slots 410, the point 404 at the first end 402 is divided into multiple sections, each such section defined by two adjacent slots 410. In this embodiment, the point 404 is prone to breakage and may not be as durable. For example, a section between two adjacent slots 410 may bend outward, or even break, through continuous use, thereby causing the protective guide 400 to get caught on a corner or other obstacle in a conduit or opening. However, the use of multiple slots 410 results in the protective guide 400 being more flexible and versatile in that it would readily accept different types of fish tapes.

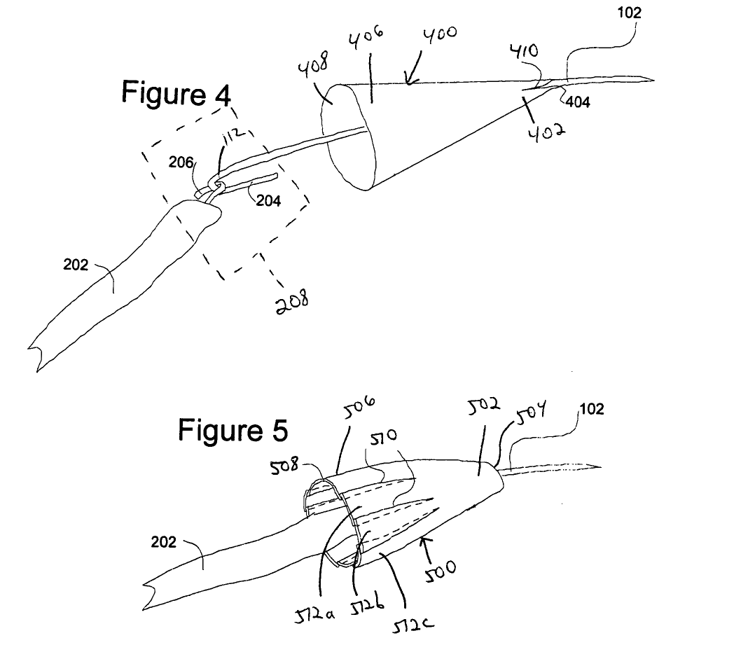

Another alternative embodiment of the invention is shown in FIG. 5, in which a protective guide 500 has one or more lateral slits 510 cut into and through its outer surface at its second end 506, thereby creating one or more sections 512a-c extending a predefined length from the second opening 508 at the second end 506 of the protective guide 500 toward the first end 502. The lateral slits 510 allow the sections 512a-c to collapse and overlap on top of each other in response to external pressure, e.g., pressure exerted on the protective guide 500 by a narrow opening. Lateral slits 510 allow for a change in the diameter of the protective guide 500 while essentially maintaining its cone or bullet shape and a smooth transition for the connection zone 208.

In operation, an end 112 of a fish tape 102, preferably having a hook 204 as shown for securing an object 202, e.g., a cable or wire to be fished through an opening, is fed through a conduit or opening, for example, in or behind a wall. The end 112 of the fish tape 102 is inserted through the first opening 110 in first end 106 of protective guide 100 such that the end 112 of the fish tape 102 is within the hollow cavity of the protective guide 100. First opening 110 preferably has a diameter sufficiently large to allow the end 112 (the hook 204) to be inserted through.

Alternatively, as shown in FIG. 4, a protective guide 400 is a hollow tube that tapers from a second end 406 with a second opening 408 to a point 404 at a first end 402. The opening at the point 404 may have a diameter smaller than the hook 204 at the end 112 of the fish tape 102 , in which case, the first end 402 of the protective guide 400 has a slot 410 cut therein to allow the hook 204 at the end 112 of the fish tape 102 to be inserted through the first end 402 and into the hollow cavity of the protective guide 400. Slot 410 need only have a length and extend toward the second end 406 as far as is necessary for the diameter of the protective guide 400 to increase to a size sufficient to allow the hook 204 at the end 112 of the fish tape 102 to pass through.

Once the end 112 of the fish tape 102 is in the protective guide 100, the fish tape 102 is pushed through the protective guide 400 until the end 112 of the fish tape 102 passes through the second opening 408 in the second end 406 of the protective guide 400. The end 112 of the fish tape 102 is connected to the object 202, such as a wire or cable as shown, to be fished or pulled through an opening. As a matter of convenience only, the present invention is shown in FIGS. 1 and 4 as joining a fish tape 102 with an object 202 by a pair of hooks 204, 206. That is, the hook 204 at the end 112 of the fish tape 102 is joined with a hook 206 protruding from, or otherwise attached to, the object 202. Thus, the fish tape 102 and the object 202 are removably joined together. The use of hooks 204, 206 is for convenience purpose only. It would be readily apparent to one of ordinary skill in the relevant art to use an alternative means for removably joining the fish tape 102 and object 202.

As shown most clearly in FIGS. 2 and 4, the joining of the end 112 of the fish tape 102 with a wire or cable object 202 to be fished creates a transition region with protrusions, referred to as the connection zone 208. The present invention is described using an object 202 being a wire or cable 202 for convenience purpose only. It is readily apparent that the present invention can be used to fish any type of object 202 through an opening or conduit.

Connection zone 208 has an increased likelihood of snagging as the fish tape 102 and object 202 are pulled through an opening because of the protrusions created by joining the fish tape 102 to the object 202 to be fished. The fish tape 102 is then pulled backward, or retracted, through the first opening 110 of the protective guide 100 such that the connection zone 208 is encased by (or within the hollow cavity of) the protective guide 100. The protective guide 100 thus creates a smooth transition from the end 112 of the fish tape 102 to the object 202 being fished. See FIG. 3.

Once the connection zone 208 is encased within the protective guide 100, the fish tape 102 is pulled back through the opening into which it was originally fed. The first end 106 of the protective guide 100, having a relatively small outside diameter, leads the way. Because the connection zone 208 is contained entirely within the interior of the protective guide 100, there are no projections or protrusions for getting the connection zone 208 hung up as the fish tape 102 and object 202 are being pulled through the opening. Once back through the original opening, the object 202 is disconnected from the fish tape 102 and the object 202 can be used as desired. For example, if the object 202 is a cable or wire, as shown for convenience in the figures, the desired electrical connection is made.

### Conclusion

While various embodiments of the present invention have been described above, it should be understood that they have been presented by way of example only, and not limitation. It will be understood by those skilled in the art that various changes in form and details may be made therein without departing from the spirit and scope of the invention. Thus, the breadth and scope of the invention should not be limited by any of the above-described exemplary embodiments.

What is claimed is:

1. A protective guide for a connection zone formed at a connection between a fish tape and an object, comprising:
a means for encasing the connection zone and creating a smooth transition from the fish tape to the object, wherein said means for encasing has a hollow cavity, is adapted to be slidably disposed on the fish tape, and is of a shape and dimension for containing the connection zone within said hollow cavity.

2. The protective guide of claim 1, wherein said means for encasing is a hollow tube having a length, a first end having a first opening with a first diameter, a second end having a second opening with a second diameter, an outer surface, and an inner surface, wherein said hollow tube tapers from said second end to said first end.

3. The protective guide of claim 2, wherein said outer surface of said hollow tube is a non-stick surface.

4. The protective guide of claim 3, wherein said outer surface is either made from or coated with a nonstick material selected from the group consisting of: chlorotrifluoroethylene (CTFE), polytetrafluoroethylene (PTFE), and silicone polymers.

5. The protective guide of claim 2, wherein said first end terminates in a point.

6. The protective guide of claim 5, further comprising a slot in said first end and adapted for receiving an end of the fish tape.

7. The protective guide of claim 6, wherein said slot extends a predefined length from said first opening of said hollow tube toward said second end of said hollow tube wherein said second diameter is sufficiently large to accommodate the end of the fish tape.

8. The protective guide of claim 6, wherein said slot extends from said first end of said protective guide toward said second end of said protective guide only until a point where said second diameter of said hollow tube is sufficiently large to accommodate the end of the fish tape.

9. The protective guide of claim 2, further comprising one or more lateral slits in said second end of said hollow tube, each said lateral slit extending from said second opening toward said first end of said hollow tube a predefined length, thereby creating two or more sections, each said section extending a predefined length from said second opening at said second end of said hollow tube toward said first end.

10. The protective guide of claim 9, wherein said protective guide is made of a material allowing said sections to collapse and overlap on top of each other in response to external pressure exerted on said hollow tube.

11. The protective guide according to claim 2, wherein said protective guide is made of a material selected from the group consisting of: compressed wood fiber products, paper, leather, cloth, metal, plastic, composite materials, alloys, and combinations thereof.

12. The protective guide according to claim 2, wherein said hollow tube has a shape selected from the group consisting of generally conical, bullet, and bell.

13. The protective guide according to claim 2, wherein said hollow tube has a length about equal to and slightly longer than the connection zone between the fish tape and the object.

14. A method for encasing a connection zone formed where an end of a fish tape is joined to an object to be pulled through an opening, comprising the steps of:
(a) inserting an end of the fish tape into a first opening at a first end of a protective guide, said protective guide being a hollow tube generally conical in shape, wherein the end of the fish tape is within said hollow tube;
(b) pushing the fish tape through said first opening of said protective guide until the end of the fish tape passes through said hollow tube and comes out a second opening at a second end of said protective guide;
(c) joining the end of the fish tape to an end of the object, thereby forming the connection zone; and
(d) pulling the end of the fish tape toward said first opening of said protective guide such that the connection zone created in said step (c) is contained within said hollow tube.

15. The method of claim 14, further comprising the step of:
(e) feeding the end of the fish tape through an opening in a conduit prior to said step (a).

16. The method of claim 15, further comprising the step of:
(f) pulling the fish tape back out and through the opening in the conduit after said step (d).

17. The method of claim 16, further comprising the step of:
(g) removing the object from the end of the fish tape.

18. The method of claim 16, wherein said hollow tube has one or more lateral slits in said second end of said hollow tube, each said lateral slit extending from said second opening toward said first end of said hollow tube a predefined length, thereby creating two or more sections, each said section extending a predefined length from said second opening at said second end of said hollow tube toward said first end.

19. The method of claim 18, further comprising the step of:
(g) collapsing one or more said sections of said second end of said hollow tube causing said sections to overlap on top of each other in response to external pressure exerted on said hollow tube.
